(19) United States
(12) Patent Application Publication
(10) Pub. No.: US 2003/0031874 A1
(43) Pub. Date: Feb. 13, 2003

(54) Flame retardant optical films

(76) Inventors: Peter Todd Valinski, Martinsville, VA (US); Simon J Potter, Allentown, PA (US)

Correspondence Address: BACON & THOMAS, PLLC, 625 SLATERS LANE, FOURTH FLOOR, ALEXANDRIA, VA, 22314

(21) Appl. No.: 10/204,430

(22) PCT Filed: Mar. 15, 2001
(86) PCT No.: PCT/US01/05813

(51) Int. Cl. B32B 27/38

(52) U.S. Cl. 428/413; 428/458; 428/463; 428/520

(57) ABSTRACT

Materials for flame retardant optical films, including adhesives and coatings for fabricating flame retardant composite films useful for window shades, eg., for solar control window shade, comprise chemically bonded flame retardant components, e.g., tetrabromobisphenol A and bis(2-chloroethyl) vinyl phosphonate. Preferred adhesives are thermoset polymers comprising the reaction product of isocyanate terminated polyester urethane and tetrabromobisphenol A. Preferred coatings are the reaction product of brominated acrylated epoxy oligomer and bis(2-chloroethyl) vinyl phosphonate.

### BACKGROUND OF THE INVENTION

1. Field of the Invention

The present invention pertains to the field of sheets or films especially solar control films and solar control window shades made from such films which are susceptible to burning. More particularly, the present invention pertains to flame retardant films or sheets such as solar control films and solar control window shades made from such films which have desirable flame retardant characteristics without sacrificing the optical clarity and visible light transmission characteristics which are desired in this field of technology. The present invention also pertains to the field of compositions which can be used to form flame retardant adhesive layers and flame retardant optical layers in sheets or films especially solar control film structures and solar control window shades made from such film structures.

2. Background Information

Polymeric materials are combustible and will easily burn when subjected to sufficient heat, e.g., flame, in an oxidizing environment. The dynamics of polymer degradation are intensified when polymer materials are in a thin film structure.

Solar control window shades are typically made from flexible transparent film or sheet material which includes one or more layers of optical coatings which are designed to block or reflect certain portions of the electromagnetic spectrum. For example, solar control window shades are typically designed to block or reflect infrared and/or ultraviolet light and reduce the amount of visible light which passes therethrough while maintaining some degree of visible light transmittance. It is particularly desirable in many applications to provide a solar control window shade which has the desired the blocking and/or reflecting characteristics while maintaining good optical clarity and visible light transmittance. However, the combustibility of such window shades have become of great concern recently since such window shades are typically used indoors where they can become a fire hazard. In this regard some nations have set flame retardant criteria for such solar control window shades and the like.

Solar control window shades are generally made from a flexible transparent film structure which includes one or more layers of polyethylene terephthalate (PET). Generally an adhesive is used to bond together the PET films which are used to make the solar control window shade. In addition, the solar control window shade will also include one or more layers of coatings which are formulated and applied to provide the desired light blocking and/or reflecting characteristics.

It is very difficult to impart flame retardant characteristics to the film structures which are used to make solar control window shades without comprising the optical clarity and visible light transmittance characteristics which are desired in such film structures and solar control window shades. This is because the incorporation of typical flame retardant materials into the thin film materials used in solar control window shades degrades the optical clarity. In particular, such flame retardant materials generally produce a characteristic known as “haze” which obscures optical clarity. Adverse effects on optical clarity result from a variety of effects, e.g., the flame retardant materials have a plasticizing effect in polymeric materials, impede the curing of the coating systems, or migrate in polymeric solids which results in the additive “blooming” at the surfaces.

It would be highly desirable to formulate adhesive materials and optical coating materials which are both flame retardant and which do not compromise the optical clarity and/or visible light transmittance characteristics which are desired in this field of technology.

### SUMMARY OF THE INVENTION

It is an objective of this invention to provide a composition which can be used to make a flame retardant adhesive layer in transparent or semitransparent flexible sheets or films especially in a solar control film structure.

It is also an objective of this invention to provide a composition which can be used to make a flame retardant optical coating on a transparent or semitransparent flexible sheet or film especially on a solar control film structure.

It is also an objective of this invention to provide a flexible transparent or semi-transparent sheet or film especially a solar control film structure which includes a flame retardant adhesive layer and/or a flame retardant optical coating without degrading the desirable optical clarity and/or visible light transmission characteristics.

These and other objectives of this invention are obtained by the selection of certain flame retardant materials which are used in an adhesive and optical coating layers in the solar control film structure. While it is preferred that the invention pertains primarily to solar control films and the like, the invention can be also used with transparent films and sheets which lack solar control features (e.g., metal layers and/or dyes). The flame retardant materials which are used in this invention are chemically bonded into polymeric materials of the adhesive and coatings, preferably as an integral component of the polymeric material. The flame retardant materials used in this invention are nonmigratory, nonplasticizing and do not impede the curing process. Most importantly they do not degrade the desired optical characteristics of the film structure.

According to one aspect of this invention an organic solvent solution is provided which can be used to form a flame retardant, optically clear, thermosetting adhesive layer in the solar control film structure. The solution comprises adhesive precursor compounds dissolved in an organic solvent. The adhesive precursors are isocyanate terminated polyester urethane and tetrabromobisphenol A. The organic solution containing the adhesive precursors dissolved therein can be applied as a thin coating on a thin flexible sheet which is used to make the solar control film structure of the present invention. The sheet may be PET or any other flexible transparent polymeric sheet material which is conventionally used to manufacture solar control film structures. After the organic solution is applied to the PET sheet or other similar type of sheet, as a thin coating, the coating is then allowed to cure (thermoset) in a reaction in which the tetrabromobisphenol A reacts with the isocyanate terminated polyester urethane. Curing and evaporation of the organic solvent forms the desired flame retardant adhesive layer.

In another aspect of this invention an organic solvent solution is provided which can be used to form the optical coatings in the solar control film structure. The organic solution which is used to produce the flame retardant optical coating contains organic solvent in which are dissolved compounds which, upon curing, form a flame retardant acrylate coating. Preferably the flame retardant acrylate coating is a brominated acrylated epoxy coating. Suitable precursors for forming the brominated acrylated epoxy coating are brominated acrylated epoxy oligomer and bis(2-chloroethyl) vinyl phosphonate. Thus according to a preferred aspect of this invention the organic solution contains brominated acrylated epoxy oligomer and bis(2-chloroethyl) vinyl phosphonate dissolved in the organic solvent. The organic solution is applied to the sheet where it is cured to form the optical coating.

In another aspect this invention also provides flame retardant, optically clear composite film structures. In particular, this invention provides such a film which comprises at least one flexible sheet of transparent polymer such as polyethylene terephthalate (PET) with a flame retardant coating thereon. The preferred flame retardant coating is the reaction product of brominated acrylated epoxy oligomer and bis(2-chloroethyl) vinyl phosphonate or bis(B-chloroethyl) vinyl phosphonate. In another preferred aspect of this invention the film structure further comprises a flame retardant adhesive layer which is used to bond multiple layers of flexible sheet (e.g., PET) together.

The flexible sheet which includes the flame retardant optically clear thermosetting adhesive and/or the flame retardant optical coating, may further include any conventional solar control element which has an effect on the light transmission and/or reflection characteristics of the film structure.

Typically the embodiments of this invention which include the flame retardant adhesive layer, contain two or more transparent flexible sheets of polymeric material such as PET which are bound together with the flame retardant adhesive.

### BRIEF DESCRIPTION OF THE DRAWINGS

FIGS. 1-7 illustrate the multilayered configurations of various embodiments of the film structures according to the present invention.

### DETAILED DESCRIPTION OF THE INVENTION AND PREFERRED EMBODIMENTS

The adhesive layer and optical coating layer used in the present invention does not adversely effect the transmission of visible light through the film structure nor does it hinder the optical clarity of the film structure such as by the development of haze. As used herein, the term “visible light” means light in the wavelength range of 400 to 750 nanometers. The term “optical clarity” as used herein refers to film materials with low haze, e.g., generally less than 25% haze, more preferably less than 20% haze. Haze in an otherwise potentially optically clear polymeric material typically has the effect of scattering of visible light passing through polymeric materials. Thus, scattered visible light is a useful surrogate measurement for haze. For instance, a film characterized by 25% haze will exhibit scatter of 25% of the transmitted visible light. In an optically clear polymeric film or composite of polymeric films, optical clarity is further manifest by the ability to distinguish shapes viewed through such films.

As noted above, the film structures of this invention may include any conventional solar control element. Thus, the films of this invention may include various types of coatings, layers and compositions which effect the transmission and/or reflection of light through the film structure. Accordingly, the flame resistant solar control film structure of the present invention may include elements which block or reflect at least a portion of the incident infrared, visible or ultraviolet light.

In a preferred embodiment of the present invention the film structure has a visible light transmission in the range of 3 to 50% of incident visible light in the wavelength range of 400 to 750 nanometers. In addition, it is preferred, that the film structure of the present invention will have no more than 25% haze, preferably less than 25% haze.

Percents reported herein for the components used in the compositions are percents by weight unless stated otherwise.

One aspect of the present invention provides organic solvent solutions which are useful for making flame retardant, optically clear, thermosetting adhesive, e.g., organic solvents which contain adhesive polymer with chemically bonded flame retardant components. The preferred chemically bonded flame retardant component is tetrabromobisphenol A. A preferred adhesive comprises the reaction product of a polymeric adhesive precursor, e.g., isocyanate terminated polyester urethane, and tetrabromobisphenol A.

Another aspect of this invention provides organic solvent solution which is useful for making flame retardant optically clear coating compositions, e.g., optically clear coatings of brominated acrylated epoxy, with chemically bonded flame retardant components. A preferred chemically bonded flame retardant component is bis-(2-chloroethyl) vinyl phosphonate. Such components are preferably reacted by UV initiated free radical polymerization reaction, e.g., by the use of photoinitiators and free radical generators such as peroxides which are well known to those skilled in the art. Thus, such photoinitiators and free radical generators are advantageously included in the organic solution which is used to form the optically clear coating.

The flame retardant adhesive and coating compositions of this invention are believed to suppress the generation of free radicals. In addition the phosphonate containing coating composition supports flame retardation by promoting the formation of a char which tends to occlude oxygen access to a burning surface.

The organic solvents which may be used in this invention for the formation of the aforementioned adhesive and optical coating solvent solutions, include organic solvents such as methyl ethyl ketone (MEK), methyl isobutyl ketone (MIBK), toluene, xylene and dimethylformamide.

The flame retardant organic solvent compositions of this invention are used to make optically clear films of the present invention which are useful for transparent window shade applications. Optically clear films are typically provided as composite laminates comprising two or more optically active polyester films. Such optically active polyester films typically comprise polyethylene terephthalate (PET) film, commonly in a thickness of about 25 micrometers (1 mil) to about 100 micrometers (4 mils). In some cases the optical activity of PET film results from the incorporation of light absorbers, e.g., dyes and UV absorbers, into the PET film, the application of metal coating and/or metal oxide coating on the PET film or a combination of light absorbers and/metal/metal oxide coating. Useful metals for optically active coatings on PET films include silver, aluminum, nickel and metal oxides such as indium oxide, tin oxide and the like. Metal and oxide coatings can be in the range of about 10 to 100 nanometers. Metal and/or metal oxide layers can be applied by vacuum deposition methods well known to those skilled in the art of sputtering.

A useful optically clear, flame retardant, optical film composite of this invention comprises at least one layer of PET coated with a metal layer and adhered to at least one dyed, optically active layer of PET by a flame retardant adhesive, wherein at least one of the layers of PET film is coated with a flame retardant coating.

The flame retardant optical composites of this invention may be fabricated with sufficient amounts of flame retardant adhesive and coating to provide composites which meet national flame retardant standards such as (a) United Kingdom flame retardant specification BS 5878:Part 2:1980 (1993) and Test Method BS 5438:1976, and/or (b) German Test Method DIN 41021.

The flame retardant adhesive compositions and flame retardant coating compositions of this invention can be applied to PET film by any of a variety of methods known to those skilled in the art of film coating and composite film manufacture. Preferred methods include gravure coating and slot die coating.

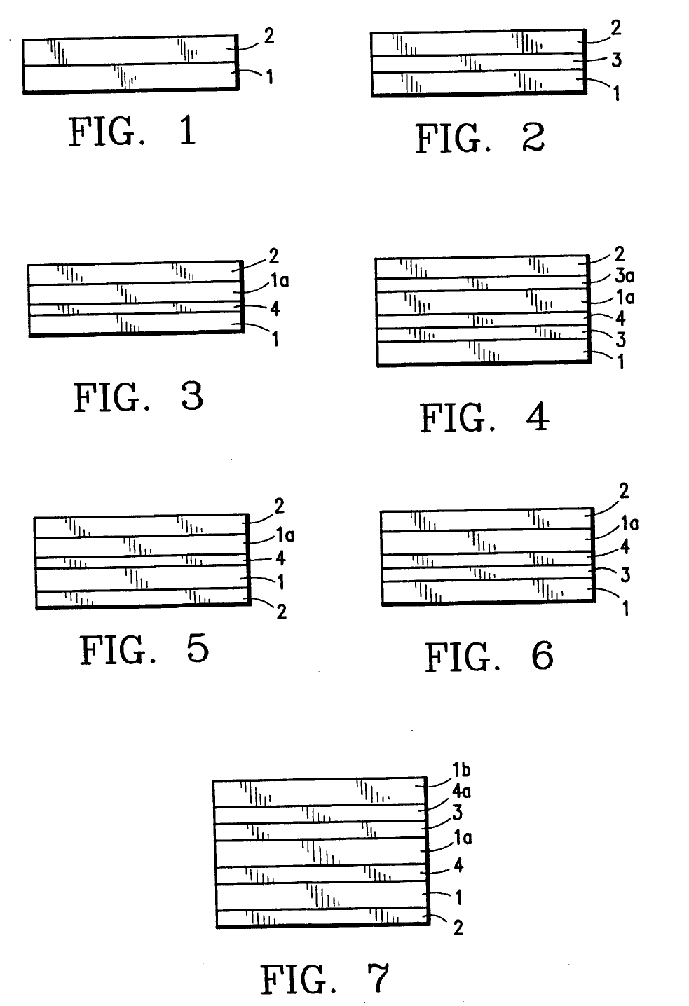

FIGS. 1-7 illustrate various embodiments of the multilayered flame retardant film structures in accordance with the present invention.

FIG. 1 illustrates an embodiment of one of the multilayered or composite film structures according to the present invention. The embodiment illustrated in FIG. 1 includes PET sheet 1 which has a coating 2 thereon. Coating 2 is a flame retardant optically clear coating (optical coating) of the present invention. Thus for example coating 2 comprises the reaction product of brominated acrylated epoxy oligomer and bis(2-chloroethyl) vinyl phosphonate.

FIG. 2 illustrates an embodiment of the invention wherein PET film or sheet 1 includes a metal layer coating 3 thereon. The metal layer 3 may be any of the conventional metal layers known to those skilled in the art which alter the optical characteristics of the PET film. Thus, the metal layer may be selected for altering the transmission of light through the PET film or for providing desired reflection or antireflection characteristics. Any of the metal coatings used in the present invention may be selected to achieve the above-noted light transmission and/or light reflection or antireflection characteristics.

The embodiment in FIG. 2 also includes flame retardant optical coating 2 which is applied onto the metal coated PET sheet. The embodiments illustrated in FIGS. 1 and 2 include only 1 PET sheet. However, as discussed above, the film structures (i.e., composite films) of the present invention may include a plurality of PET sheets. Such embodiments advantageously include a flame retardant adhesive layer of the present invention for adhering the PET sheets together. Thus, FIG. 3 illustrates an embodiment of the invention wherein PET sheet 1 is adhered to PET sheet 1a by optically clear flame retardant adhesive layer 4. The embodiment shown in FIG. 3, like the embodiment of FIG. 2, includes flame retardant optical coating 2 on a top surface thereof. It will be appreciated that while FIG. 3 only illustrates the presence of a flame retardant optical coating 2 on one surface thereof, it is contemplated that all of the embodiments of the invention may optionally include coating 2 on both exposed surfaces of the composite film (i.e., on the top surface and the bottom surface). Such an embodiment of the invention is illustrated in FIG. 5 which corresponds to the embodiment shown in FIG. 3 with the only exception being that coating 2 is on both the top and bottom surfaces of the composite.

It will be appreciated that the embodiments illustrated in FIGS. 1, 3 and 5 do not include a metal layer 3 as is shown in the embodiment of FIG. 2. Thus, the embodiments of FIGS. 1, 3 and 5 do not necessarily have to contain any coatings or ingredients which alter the light transmission and/or reflection characteristics of the composite. However, any of the PET sheets used in the present invention may optionally include any conventional dye or light absorber such as a UV light absorber to alter the light transmission characteristics of the composite film. Thus, for example, PET sheet 1 and/or PET sheet 1a, may optionally include a dye and/or UV absorber. Similarly, one or more of the PET sheets used in the present invention may have a metal coating thereon for affecting the light transmission and/or light reflection or antireflection characteristics of the composite film. Accordingly, FIG. 4 illustrates an embodiment of the invention wherein both PET sheets 1 and 1a have a metal coating 3 and 3a thereon respectively. The embodiment of FIG. 4 also includes flame retardant optical coating 2 on a top surface thereof. As noted above, the flame retardant optical coating 2 may also be included on the bottom surface thereof.

FIG. 6 shows another embodiment of the invention wherein only one of the PET sheets includes a metal layer thereon. Thus the embodiment shown in FIG. 6 includes PET sheet 1 having a coating of metal 3 thereon. The PET sheet 1a is adhered to the metal coated PET sheet 1 by the flame retardant adhesive layer 4. Lastly, flame retardant optical coating 2 is located on a top surface of the composite film although, as noted above, flame retardant optical coating 2 may be located on both surfaces of the composite film.

As noted above, any of the PET sheets may include a dye and/or light absorber (e.g., UV absorber). Thus, for example, PET layers 1 and/or 1a may include a dye or UV absorber incorporated therein. In a preferred embodiment PET sheet 1a includes a dye or UV absorber.

FIG. 7 illustrates an embodiment of the invention which includes three PET sheets 1, 1a and 1b. PET sheet 1a is shown in FIG. 7 as having metal coating 3 thereon. However, it will be appreciated that any of the PET sheets used in the composite films of the present invention may include a metal layer coating thereon. Flame retardant optically clear adhesive layers 4 and 4a are used in the embodiment shown in FIG. 7 for joining PET sheet 1b to the metal coated PET sheet 1a and for joining PET sheet 1a with PET sheet 1. Lastly, one surface of the composite shown in FIG. 7 is coated with a flame resistant optical coating 2 although, such a coating may be formed on both surfaces of the composite film. FIG. 7 illustrates the composite film described in example 4 when PET sheets 1 and 1b include a dye as a component thereof.

It will be appreciated that the above figures are for purposes of illustration only and are not drawn to scale to show the thicknesses of the various layers in the composite film.

### EXAMPLE 1

This example illustrates the preparation of a flame retardant adhesive composition according to this invention. Solutions useful for flame retardant adhesive compositions are prepared by mixing a minor amount by weight of brominated flame retardant polyol, e.g., tetrabromobisphenol A, and a major amount by weight of a polymeric adhesive precursor, e.g., isocyanate terminated polyester urethane, in an organic solvent. In particular, such compositions are prepared by mixing 1 to 5 parts by weight tetrabromobisphenol A, 30 to 60 parts by weight isocyanate terminated polyester urethane and 30 to 60 parts by weight organic solvent (a mixture of MEK and toluene. A preferred reaction mixture composition comprises 2.4% tetrabromobisphenol A obtained from Albermerle Corporation as Saytex RB-100 flame retardant, 48.0% isocyanate terminated polyester urethane obtained from Rohm an Haas Inc. as Adcote 527, 33.3% MEK and 16.6% toluene.

### EXAMPLE 2

This example illustrates the preparation of a solvent composition useful for making the flame retardant optical coating layer used in the present invention. Solutions useful for making the flame retardant coating are prepared by mixing a minor amount by weight of phosphonate substituted vinyl monomer, e.g., bis(2-chloroethyl) vinyl phosphonate, and a major amount by weight of a brominated acrylated epoxy polymer. Such vinyl phosphonate monomers are polymerizable by free radical mechanisms. In particular, such compositions are prepared by mixing 10 to 20 parts by weight bis(2-chloroethyl) vinyl phosphonate with 40 to 80 parts by weight of brominated acrylated epoxy oligomer in 10 to 20 parts by weight of organic solvent such as toluene, and up to about 5 parts by weight of polymerization initiator (e.g., peroxide or sulfonic acid). A preferred reaction mixture composition comprises 64% brominated acrylated epoxy oligomer obtained from UCB Chemicals Corp. as IRR 1031, 16.8% bis(2-chloroethyl) vinyl phosphonate obtained from Akzo Nobel Chemicals, Inc. as Fryol Bis-2, 2.3% polymerization initiator obtained from Ciba Geigy Corp. as Irgucure 184, 0.5% initiator obtained from Ciba Geigy Corp. as Irgacure 907 and 16.6% toluene.

### EXAMPLE 3

This example illustrates the preparation of flame retardant, optically clear composite films of this invention which comprise at least one sheet of polyethylene terephthalate with a flame retardant coating which is the reaction product of brominated acrylated epoxy oligomer and bis(2-chloroethyl) vinyl phosphonate. This example further illustrates the use of the flame retardant adhesive composition of this invention to adhere at least two layers of PET film in a composite of this invention. A 50 micrometer (2 mil) thick PET film coated with 50 nanometers of aluminum is adhered to a 25 micrometer (1 mil) thick dyed PET film with a 1.5 micrometer thick layer of the adhesive prepared according to example 1. The exposed side of the dyed PET film is coated with a 15.6 micrometer thick layer of the coating composition prepared according to example 2. The composite film is substantially haze free, i.e., exhibits less than 25% haze; is transparent to visible light, i.e., is transparent to greater than 5% of incident visible light; and meets the above-noted flame retardant standards of the United Kingdom and Germany.

### EXAMPLE 4

This example illustrates a flame retardant, optically clear composite film comprising three layers of PET film. A first 25 micrometer (1 mil) thick dyed PET film is coated with a 1.5 micrometer thick layer of flame retardant adhesive prepared according to example 1 and laminated to a 50 micrometer (2 mil) thick PET film coated with a 50 nanometer thick layer of aluminum and a 1.5 micrometer thick layer of the flame retardant adhesive and laminated to a 25 micrometer (1 mil) thick dyed PET film coated with 15.6 micrometer thick flame retardant coating prepared according to example 2.

While the present invention has been described in terms of certain preferred embodiments, one skilled in the art will readily appreciate that various modifications, changes, omissions and substitutions may be made without departing from the spirit thereof. It is intended, therefore, that the present invention be limited solely by the scope of the following claims.

We claim:

1. A composite film structure which comprises a first flexible transparent polymeric sheet which optionally includes a metal or metal oxide coating thereon; said film structure having a flame retardant acrylate optical coating layer on at least one of two exposed surfaces thereof.

2. The composite film structure of claim 1 wherein said transparent sheet is PET.

3. The composite film structure of claim 2 wherein said optical coating is brominated acrylated epoxy polymer.

4. The composite film structure of claim 3 wherein said brominated acrylated epoxy polymer is the reaction product of brominated acrylated epoxy oligomer and bis(2-chloroethyl) vinyl phosphonate.

5. The composite film structure of claim 4 wherein said PET includes a dye or a UV absorber as a component thereof.

6. The composite film structure of claim 4 wherein said PET sheet includes a metal or metal oxide coating thereon.

7. The composite film structure of claim 4 which further includes a second flexible transparent PET sheet which optionally includes a metal or metal oxide coating thereon; said second flexible transparent PET sheet being adhered to said first transparent PET sheet by a flame retardant optically clear adhesive layer wherein said adhesive layer is the reaction product of isocyanate terminated polyester urethane and tetrabromobisphenol A.

8. The composite film structure of claim 7 wherein said first PET sheet or said second PET sheet includes a metal or metal oxide coating thereon.

9. The composite film structure of claim 7 wherein said first PET sheet or said second PET sheet includes a dye or UV absorber as a component thereof.

10. The composite film structure of claim 8 which comprises the following layers in order:
(a) a first sheet of PET;
(b) a layer of metal;
(c) a layer of flame retardant adhesive which is the reaction product of isocyanate terminated polyester urethane and tetrabromobisphenol A;
(d) a second sheet of PET; and
(e) a flame retardant coating which is the reaction product of brominated acrylated epoxy oligomer and bis(2-chloroethyl) vinyl phosphonate.

11. The composite film structure of claim 10 which meets at least one of the following flame retardant standards:
(a) German Test Method DIN 4102; and
(b) UK Test Method BS5428:1976.

12. The film structure of claim 11 which has a visible light transmission in the range of 3 to 50% of incident visible light in the wavelength range of 400 to 750 nanometers.

13. The film of claim 11 which has less than 25% haze.

14. The composite film structure of claim 10 wherein said first PET sheet is about 50 micrometers thick; said metal layer is aluminum having a thickness of about 50 nanometers; said layer of flame retardant adhesive has a thickness of about 1.5 micrometers; said second sheet of PET is dyed PET having a thickness of about 25 micrometers; and said flame retardant coating has a thickness of about 15.6 micrometers.

15. The composite film structure of claim 7 which further includes a third flexible transparent PET sheet which optionally includes a metal or metal oxide coating thereon; said third flexible transparent PET sheet being adhered to said second transparent PET sheet with a flame retardant optically clear adhesive layer which is the reaction product of isocyanate terminated polyester urethane and tetrabromobisphenol A.

16. The composite film structure of claim 15 which comprises the following layers in order:
(a) a first dyed PET sheet;
(b) a layer of flame retardant adhesive which is the reaction product of isocyanate terminated polyester urethane and tetrabromobisphenol A;
(c) a second sheet of PET having a layer of aluminum coated thereon;
(d) a layer of flame retardant adhesive which is the reaction product of isocyanate terminated polyester urethane and tetrabromobisphenol A;
(e) a second dyed PET sheet; and
(f) a flame retardant coating which is the reaction product of brominated acrylated epoxy oligomer and bis(2-chloroethyl) vinyl phosphonate.

17. A composite film of claim 16 wherein said first and second dyed PET sheets are about 25 micrometers thick; said first and second layers of flame retardant adhesive are about 1.5 micrometers thick; said second sheet of PET has a thickness of about 50 micrometers and said aluminum coating thereon is about 50 nanometers thick; and said flame retardant coating is about 15.6 micrometers thick.

18. An organic solution for forming a flame retardant optically clear thermosetting adhesive; said organic solvent solution comprising organic solvent, isocyanate terminated polyester urethane and tetrabromobisphenol A.

19. The organic solvent solution of claim 18 which comprises:
(a) 1 to 5 parts by weight of tetrabromobisphenol A;
(b) 30 to 60 parts by weight of isocyanate terminated polyester urethane; and
(c) 30 to 60 parts by weight of organic solvent.

20. An organic solvent solution for forming a flame retardant optically clear brominated acrylated epoxy coating; said organic solvent solution comprising organic solvent; brominated acrylated epoxy oligomer and bis(2-chloroethyl) vinyl phosphonate.

21. The organic solvent solution of claim 20 which comprises:
(a) 40 to 80 parts by weight of brominated acrylated epoxy oligomer;
(b) 10 to 20 parts by weight of bis(2-chloroethyl) vinyl phosphonate;
(c) 1 to 5 parts by weight of photoinitiator; and
(d) 10 to 20 parts by weight of organic solvent.
